(19) United States
(12) Patent Application Publication
(10) Pub. No.: US 2003/0016993 A1
(43) Pub. Date: Jan. 23, 2003

(54) Tool kit with replaceable tool anchor device

(76) Inventor: Ching Chen, Taiping City (TW)

Correspondence Address: Keith Kline, PRO-TECHTOR INTERNATIONAL SERVICES, 20775 Norada Court, Saratoga, CA, 95070-3018, US

(21) Appl. No.: 09/908,067

(22) Filed: Jul. 17, 2001

(51) Int. Cl. F16D 1/00; B25G 3/18; F16B 21/00

(52) U.S. Cl. 403/329

(57) ABSTRACT

A tool kit comprises a body including a recess and four dents each on one of four sides abutted the recess, a detachable anchor mechanism shaped to snugly fit in the recess and including a plurality of slots each for fastening a tool therein and four side latched members secured to the dents, and a hinged door above the anchor mechanism.

### FIELD OF THE INVENTION

The present invention relates to tool kit and more particularly to an improved tool kit with replaceable tool anchor device.

### BACKGROUND OF THE INVENTION

A conventional tool kit 1 is shown in FIG. 1 having a tool anchor device 2 including a plurality of elongate slots 3 each for fastening a tool 4 therein. But this is unsatisfactory for the purpose for which the invention is concerned for the following reasons. 1. Tool anchor device 2 is integrally formed with tool kit 1. Thus it is impossible of adapting the tool anchor device 2 to fasten tools having shapes other than predetermined ones. Further, in almost all cases that such integrally formed tool anchor device 2 has the same color as tool kit 1. Hence, it is less attractive to consumers as it displayed in a store. Thus, it is desirable to provide an improved tool kit with replaceable tool anchor device in order to overcome the above drawbacks of prior art.

### SUMMARY OF THE INVENTION

It is therefore an object of the present invention to provide a tool kit comprising a body including a recess and four dents each on one of four sides abutted the recess; a detachable anchor mechanism shaped to snugly fit in the recess and including a plurality of slots each for fastening a tool therein and four side latched members secured to the dents; and a hinged door above the anchor mechanism.

The above and other objects, features and advantages of the present invention will become apparent from the following detailed description taken with the accompanying drawings.

### BRIEF DESCRIPTION OF THE DRAWINGS

FIG. 1 is a perspective view of a conventional tool kit;

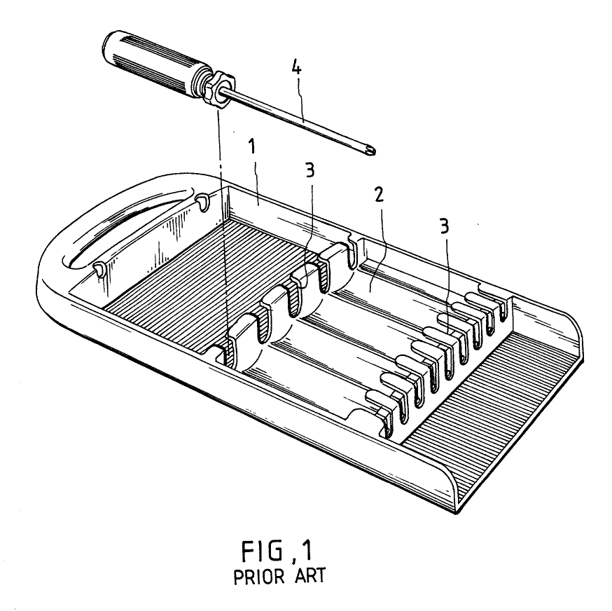

FIG. 2 is an exploded perspective view of a portion of a tool kit incorporating a first preferred embodiment of replaceable tool anchor device according to the invention;

FIG. 3 is a lateral cross-sectional view of tool anchor device, door, and tool kit;

FIG. 4 is a longitudinal cross-sectional view of tool anchor device, door, and tool kit; and

FIG. 5 is an exploded perspective view of a portion of a tool kit incorporating a second preferred embodiment of replaceable tool anchor device according to the invention.

### DETAILED DESCRIPTION OF THE PREFERRED EMBODIMENTS

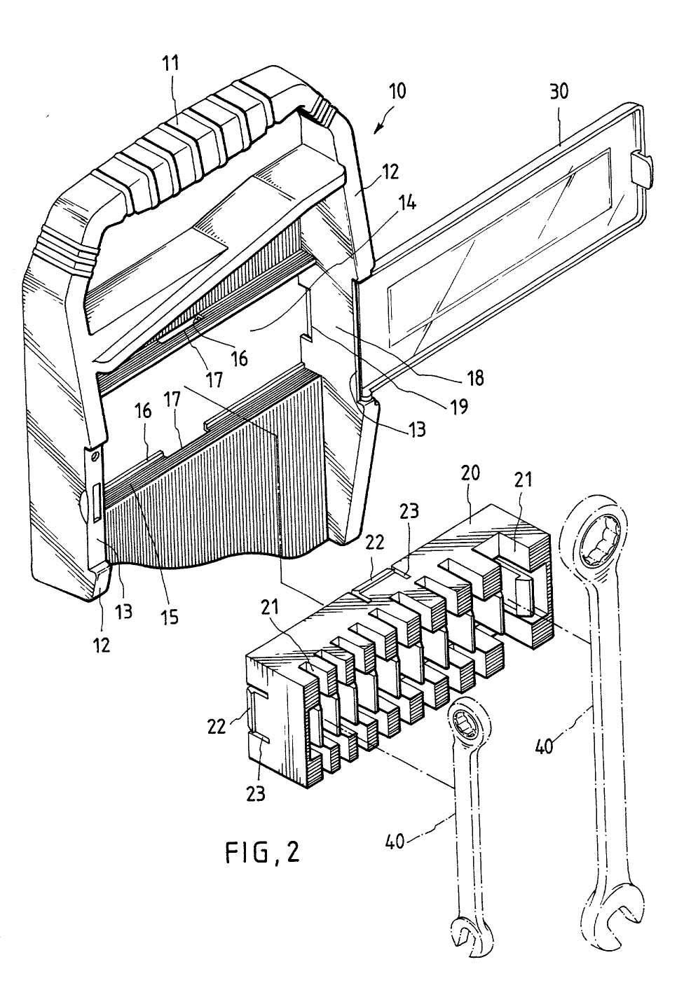

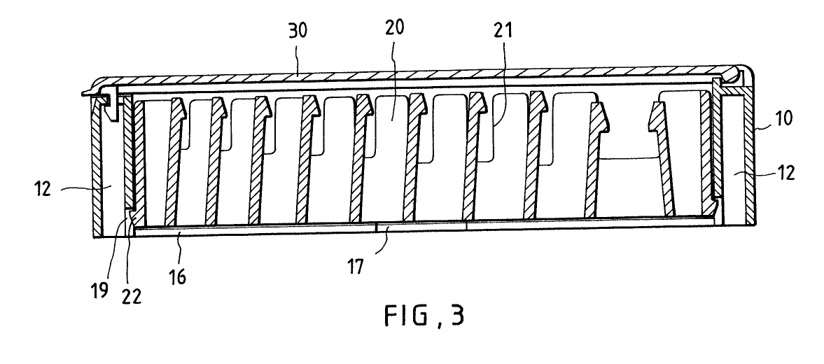

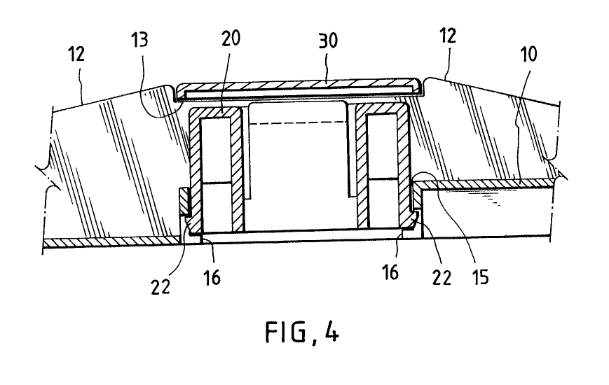

Referring to FIGS. 2 to 4, there is shown a tool kit 10 constructed in accordance with the invention. The tool kit 10 comprises a recess 14, an elongate stop 16 on either top or bottom inner side 15, a first dent 17 on the center of each stop 16, a second dent 19 on either inner side 18, a tool anchor device 20 shaped to snugly fit in recess 14 and including a plurality of slots 21 (may be varied in shape) on outer side each for fastening a tool (e.g., combination box and open end wrench as shown in FIG. 2) 40 therein and four latched members 22 on four sides each spaced apart from one side by two opposite gaps 23 so as to possess a flexibility, and a hinged door 30 (i.e., hinged to a recessed portion 13 on one side 12 and secured to another recessed portion 13 on the other side 12 in a closed position) above tool anchor device 20. In assembly, snap tool anchor device 20 into recess 14 until contacting the stops 16. Then insert latched members 22 into first and second dent 17 and 19 respectively for securing.

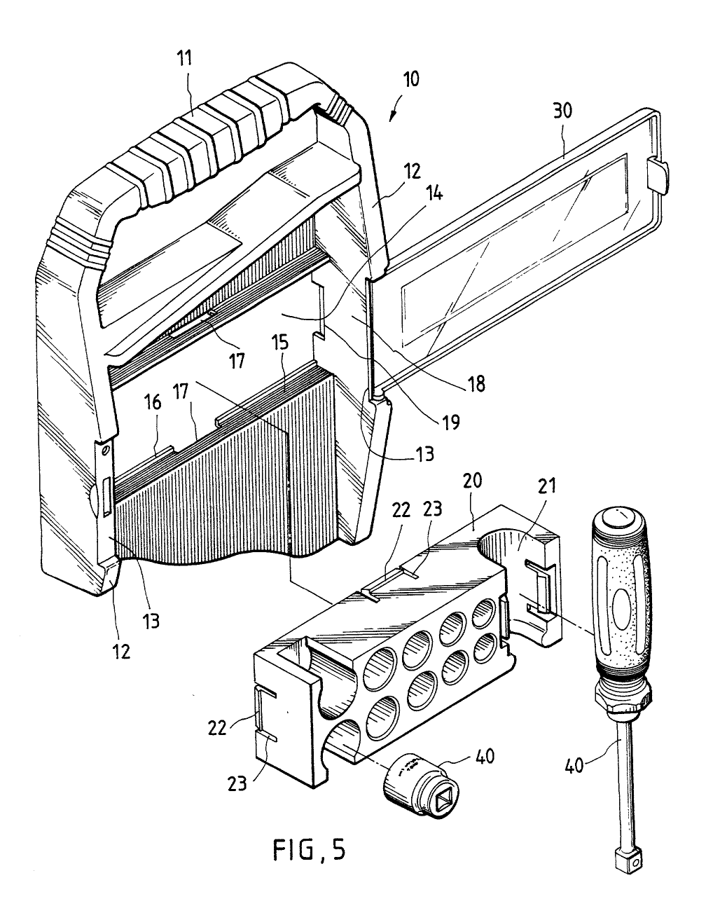

Referring to FIG. 5, there is shown a portion of a tool kit 10 incorporating a second preferred embodiment of replaceable tool anchor device 20 according to the invention. The slots 21 of this tool anchor device 20 have shapes different from that shown in FIG. 2 so as to fasten different tools (e.g., head and chuck of combination screwdriver as shown) 40.

The advantages of the invention are as follows: Tool anchor device 20 is formed separated from the body of tool kit 10. Hence, it is possible of replacing the tool anchor device 20 when it is worn. Further, the color of tool anchor device 20 may be different from that of the remaining portion of tool kit 10 so as to attract consumer when it is displayed in a store.

While the invention has been described by means of specific embodiments, numerous modifications and variations could be made thereto by those skilled in the art without departing from the scope and spirit of the invention set forth in the claims.

What is claimed is:

1. A tool kit comprising:
a body including a recess and four dents each on one of four sides abutted said recess;
a detachable anchor mechanism shaped to snugly fit in said recess and including a plurality of slots each for fastening a tool therein and four side latched members secured to said dents; and
a hinged door above said anchor mechanism.

2. The tool kit of claim 1, further comprising an elongate stop on either a top or bottom side abutted said recess.

3. The tool kit of claim 1, further comprising two gaps on each of four sides of said anchor mechanism with said latched member disposed therebetween.
